(19) United States
(12) Patent Application Publication
(10) Pub. No.: US 2025/0058715 A1
(43) Pub. Date: Feb. 20, 2025

(54) Cargo Access Apparatus for Truck Beds

(71) Applicant: James M. Wilcox, Dunnellon, FL (US)

(72) Inventor: James M. Wilcox, Dunnellon, FL (US)

(21) Appl. No.: 18/806,595

(22) Filed: Aug. 15, 2024

Related U.S. Application Data
(60) Provisional application No. 63/520,037, filed on Aug. 16, 2023.

(51) Int. Cl. B60R 9/06

(52) U.S. Cl. CPC B60R 9/06

(57) ABSTRACT

A cargo access apparatus for pickup trucks having a cargo box, the apparatus comprising at least one lightweight cargo access tray comprising a floor having a perimeter, a top cargo supporting surface, and a bottom bed contacting surface for slidable and frictional engagement with the cargo box floor, and a cargo retaining wall attached to or integrally formed with the tray floor about its perimeter, whereby the at least one tray may be pulled rearwardly over the tailgate to load or unload the cargo.

### CROSS-REFERENCE TO RELATED APPLICATIONS

This application claims the benefit of U.S. Provisional Application No. 63/520,037 filed Aug. 16, 2023 and entitled, Lightweight Cargo Access Trays (LCAT) for Pickup Trucks.

### FIELD OF THE INVENTION

This invention pertains to the improved utility of truck beds generally, and to an apparatus that facilitates storage, loading and retrieval of lightweight cargo from the bed of pickup trucks in particular.

### BACKGROUND OF THE INVENTION

A truck bed, also known as a cargo box, refers to the open area at the rear of a pickup truck that is used to haul cargo.

Pickup trucks have become increasingly popular in the United States, accounting for more than four out of every five new cars sold in 2024. In 2023, they were the top three selling vehicles, with the Ford F-150 leading the way for the 47th year in a row. Pickup trucks are also popular worldwide, with projected revenue of $123.2 billion in 2024 and 4.145 million units sold by 2028. Truck beds are categorized as either “standard” shortbed at six feet five inches, or “standard” longbed, which is only slightly longer (approximately seven feet), as measured from the front of the bed (just behind the cab) to the edge (at the tailgate). However, in addition to the standard sizes, there are also true short- and long bed dimensions. The former boxes measure between five feet five inches, and five feet eight inches, and big longbeds are eight feet in length. Even the smallest of the foregoing bed sizes is useful for hauling a diverse range of cargo including groceries, luggage, boxed items, landscaping materials, outdoor gear/sports equipment, garbage, and a myriad of other products and materials.

While the ability of pickup trucks to haul significant amounts of cargo is a desirable feature, the effort required to access items in the truck bed can be less desirable. Both the cargo box's side walls and the tailgate, whether in its upright closed position or its lowered open position, impede access to cargo within the bed. When the tailgate is lowered, only the first few feet of the cargo box are within reach. Cargo deeper in the bed can only be accessed with the aid of some elongated tool or by climbing up into the truck bed which can be challenging for many owners. The latter practice is all to often accompanied by slips, falls, strains or other potential hazards or injuries and is made even more difficult when the cargo is covered by some sort of topper or cap which must be opened, removed or avoided to gain access to the bed. Accordingly, many owners have resorted to placing cargo only in the area immediately behind the tailgate. However, unless this cargo is secured in place in some manner it inevitably finds its way to the opposite end of the bed.

Based on the above challenges associated with retrieval of cargo from pickup truck beds, a variety of aftermarket accessory apparatus have been devised to increase ease of access to stored cargo items. Many of such apparatus of the prior art involved the development of plates that slidably engage the floor of the pickup bed cargo area floor via roller means. Several examples of this approach are presented in the following patents and patent application publications: U.S. Pat. No. 6,328,364 entitled, Pull Out Drawer System for Vehicles and Trailers, U.S. patent Ser. No. 11/584,305 entitled, Truck Bed Slidable Storage System, U.S. Pat. No. 4,305,695 entitled, Rollout Tray For Panel Truck Bed, U.S. Pat. No. 5,934,725 entitled, Extendable Vehicle Bed Sliding Tray,

U.S. Pat. No. 8,840,166 entitled, Slidable Cargo Area Floor Liner and Cargo Management Device, U.S. patent Ser. No. 10/850,670 entitled, Removable Roller Tray, U.S. Pat. App. Publication No. 2023/018265 entitled, Slide Out Device For Vehicle, U.S. Pat. App. Publication No. 2010/0327616 entitled, Pickup Truck Bed Slider, and U.S. Pat. App. Publication No. 2022/0055542 entitled, Truck Bed Slidable Storage System. While these inventions provide ease of access to loaded cargo items, their construction is unnecessarily complex and incorporates invasive mounting mechanisms, which in most if not all cases require drilling holes into the floor or walls of the truck cargo bed. Also, the roller means by which the load floor/plate engages the floor of the cargo area is susceptible to mechanical failure during the course of typical usage of a truck bed cargo area (i.e., rollers inhibited by dirt and debris or broken/damaged as a result of loading and hauling of heavy items). Still further, many such inventions are heavy, take up valuable cargo space and may require disassembly and removal when they are not compatible with the cargo such as loads of dirt, sand or other loose construction materials for example. Finally, examples of such inventions currently available from aftermarket manufactures are relatively expensive (ranging from approximately $700 to $2,000) due in part to their complexity and manufacturing cost.

It would be a benefit, therefore, to have a slidable cargo access apparatus that does not require invasive mounting mechanisms and would allow a user to quickly pull cargo within the bed to within easy reach without resort to climbing into the bed.

### SUMMARY OF THE INVENTION

Disclosed is a cargo access apparatus for pickup trucks having a cargo box comprising a floor, a pair of opposing vertical side walls, an optional wheel well defining structure extending from each of the opposing vertical side walls, a transverse front wall and a tailgate opposite the front wall and pivotally mounted to the pair of side walls, the pair of opposing vertical side walls, (and optional wheel well defining structures if present), transverse front wall and tailgate defining an area, the floor, pair of opposing vertical side walls (and optional wheel well defining structures if present), transverse front wall and tailgate defining a cargo space for receiving cargo, the cargo access apparatus comprising at least one cargo access tray sized to occupy substantially all of the area between the cargo bed side walls, on the one hand, and between the transverse front wall and tailgate of the cargo box, on the other hand, when oriented in side-by-side fashion on the cargo box floor, the at least one cargo access tray comprising a floor having a perimeter, a top cargo supporting surface, and a bottom bed contacting surface; and a cargo retaining wall attached to or integrally formed with the tray floor about the perimeter; whereby the bottom bed contacting surface is adapted for slidable and frictional engagement with the cargo box floor; and whereby each of the at least one tray may be independently pulled rearwardly over the tailgate to load or unload cargo onto said cargo supporting surface. In preferred embodiments, the at least one tray is two trays. In preferred embodiments, the pair of trays are equal in size. In preferred embodiments, the at least one tray is substantially rectangular in shape and is sized to occupy substantially all of the area between the cargo bed side walls (or between the wheel well defining structures when present) and between the transverse front wall and tailgate.

In addition to one or more of the features described above or below, or as an alternative, in further embodiments the bottom bed contacting surface of the tray floor may be of a ribbed, waffle or honeycomb configuration to reduce friction with the cargo box floor, to reduce weight of the tray, to impart impact resistance, and to increase strength-to-weight ratio.

In addition to one or more of the features described above or below, or as an alternative, in further embodiments the retaining wall is comprised of a pair of opposing side walls each having a first end and a second end, the first end being connected to or integrally formed with a first transverse retaining wall proximate to the transverse front wall of the cargo bed, and the second end being connected to or integrally formed with a second transverse retaining wall proximate the tailgate, when the at least one tray is fully positioned within the cargo bed.

In addition to one or more of the features described above or below, or as an alternative, in further embodiments the cargo retaining wall is either normal to the tray floor or, more preferably, canted outwardly to facilitate stacking of the subject cargo access trays.

In addition to one or more of the features described above or below, or as an alternative, in further embodiments at least one of the pair of tray side walls and first and second transverse retaining walls is adapted with at least one slot, preferably but not essentially oval in shape, and sized to permit receipt of a user's fingers to facilitate sliding of the tray into and out of the cargo bed and, when at least two such apertures are present on opposite sides of the tray, to facilitate lifting of the tray and, if present, its cargo.

In addition to one or more of the features described above or below, or as an alternative, in further embodiments the pair of opposing side walls of the at least one tray may include at least one transverse partition wall, intermediate the first and second transverse retaining walls to facilitate segregation and organization of cargo.

In addition to one or more of the features described above or below, or as an alternative, in further embodiments the at least one transverse partition wall may be removably mounted at opposite ends within a pair of opposing slots or bosses.

In addition to one or more of the features described above or below, or as an alternative, in further embodiments the pair of opposing side walls and/or first and second transverse retaining walls of the at least one tray may be adapted with a plurality of apertures therethrough for removable receipt of cargo retention means such as cargo nets, tie-down straps and the like.

In certain embodiments, the at least one tray floor or cargo retention wall may be perforated with one or more drain holes which can be used to permit draining of rainwater or any other liquid from the tray into the truck bed if that feature is desired. These drain holes may be plugged with rubber or plastic plugs to prevent drainage onto the truck bed if desired.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is, therefore, a primary object of the subject invention to provide a lightweight cargo access apparatus that can be deployed in cargo box of a pickup truck in slidable engagement with the box floor and easily withdrawn over the tailgate to facilitate loading and unloading of cargo thus avoiding the need to climb into the cargo box to retrieve out of reach items.

It is, therefore, a primary object of the subject invention to provide a lightweight cargo access apparatus comprising at least one, and preferably two, trays generally sized to occupy substantially the entire area of a cargo box floor between the box's opposing vertical side walls (or between the wheel well defining structures when present), on the one hand, and between the box's front wall and tailgate, on the other hand.

It is another primary object of the subject invention to provide a cargo access apparatus that is fabricated from materials that are lightweight, strong, durable, corrosion- and UV-resistant, and non-absorbent.

Another object of the subject invention is to provide a cargo access apparatus that is produced from materials that may be finished to possess a smooth, easily cleanable surface.

Still another object of the subject invention is to provide a cargo access apparatus that is fabricated from materials that are resistant to pitting, chipping, crazing, scratching, scoring, distortion and decomposition.

It is also an object of the subject invention is to provide a cargo access apparatus that is constructed to be free of breaks, open seams, cracks, chips, inclusions, pits, and similar imperfections.

Still another object of the subject invention is to provide a cargo access apparatus that is susceptible of a low cost of manufacture with regard to both materials and labor, and which accordingly is then susceptible of low prices of sale to the consuming public.

It is a still further object of the invention to provide a cargo access apparatus that accomplishes all or some of the above objects in combination.

These together with other objects of the invention, along with the various features of novelty which characterize the invention, are pointed out with particularity in the claims annexed to and forming a part of this disclosure. For a better understanding of the invention, its advantages and the specific objects attained by its uses, reference should be had to the accompanying drawings and descriptive matter in which there is illustrated a preferred embodiment of the invention.

### BRIEF DESCRIPTION OF DRAWINGS

The invention will be better understood and objects other than those set forth above will become apparent when consideration is given to the following detailed description thereof. Such description makes reference to the annexed drawings wherein:

FIG. 1 is a top view of typical pickup truck having an open cargo bed;

FIG. 2 is a top view of an embodiment of a pair of cargo trays of the subject invention deployed within the cargo bed of the pickup truck of FIG. 1, in accordance with a non-limiting example;

FIG. 3 is a right rear quarter perspective view of a pair of cargo trays of the subject invention deployed within the cargo bed of a typical pickup truck, in accordance with a non-limiting example;

FIG. 4 is a top view of an embodiment of a cargo access tray of the subject invention, in accordance with a non-limiting example;

FIG. 5 is a bottom view of an embodiment of a cargo access tray of the subject invention, in accordance with a non-limiting example;

FIG. 6 is a side elevation view of an embodiment of a side retaining wall of the subject invention, in accordance with a non-limiting example;

FIG. 7 is a front elevation view of an embodiment of a transverse retaining wall of the subject invention, in accordance with a non-limiting example; and

FIG. 8 is sectional view of an embodiment of a cargo access tray of the subject invention taken along line 8-8 of FIG. 4, in accordance with a non-limiting example.

### DETAILED DESCRIPTION OF THE INVENTION

At the outset, it should be clearly understood that like reference numerals are intended to identify the same structural elements, portions or surfaces consistently throughout the several drawings figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. The figures provided herewith are for explanation purposes to persons ordinarily skilled in the art and that the drawings are not necessarily drawn to scale. One of ordinary skill in the art will also appreciate that a component may be designed as multiple components or that multiple components may be designed as a single component.

Furthermore, reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “in some embodiments”, “one example” or “an example” in various places throughout this specification are not necessarily all referring to the same embodiment or example. Furthermore, the particular features, structures or characteristics may be combined in any suitable combinations and/or sub-combinations in one or more embodiments or examples.

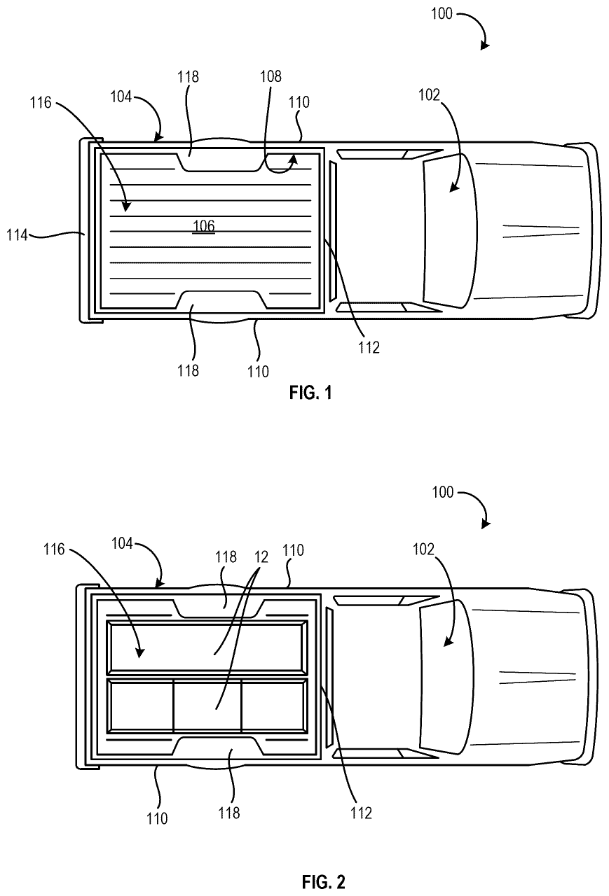

Before describing the various embodiments of the subject cargo trays it is helpful to first describe, very basically, a typical vehicle cargo box in which they are deployed. Accordingly, reference is first made to FIG. 1 in which there is illustrated a typical pickup truck 100 (hereinafter also referred to more simply as “pickup 100” or and “truck 100”) portions of which have been eliminated or simplified when not important to an understanding of the invention. Pickup 100 is generally comprised of a cabin 102 for housing of the vehicle's driver and passengers and a cargo bed 104 (also referred to herein as “cargo box 104”) at the tail end of the vehicle. Cargo box 104 is comprised of a floor 106 having a perimeter 108 defined by a pair of opposing vertical side walls 110 joined together at one end by a transverse front wall 112 adjacent the truck's cabin 102 and a tailgate 114 pivotally mounted to side walls 110 parallel to front wall 112 when the tailgate is in its closed upright position. Together, floor 106, side walls 110, front wall 112 and tailgate 114 define an open cargo space 116 (also known as a “tonneau”) into which cargo is placed for storage or transport. Cargo box 104 may also include a pair of wheel well defining structures 118 extending from each side wall 110 partially into cargo space 116 thus changing the shape of perimeter 108 from generally rectangular to hourglass. Wheel well defining structures 118 are present in most standard-sized and larger pickups 100. Cargo box 104 may further include a variety of different covers including but not limited to a variety of hard or soft “tonneau covers”, caps (aka “toppers”), camper shells or pop-up style tents (not shown). These covers can be fitted to sit slightly above cargo box height, at cab height, or may be of the mid-rise or high-rise variety.

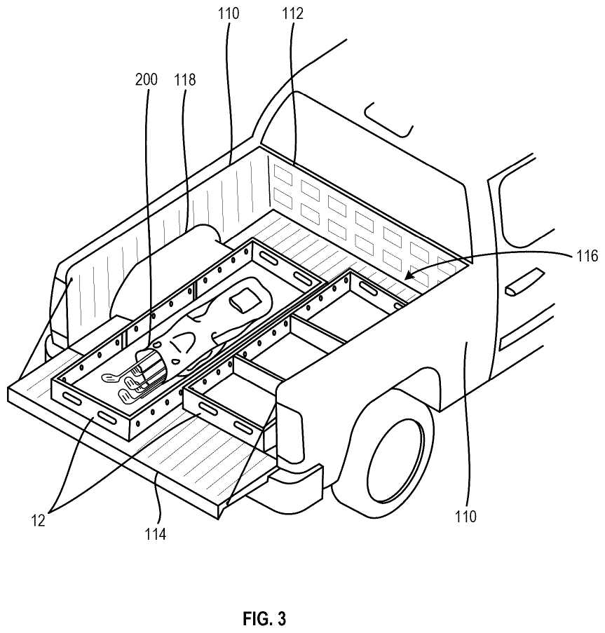

Reference now being made to FIGS. 2 through 4, this disclosure relates to a cargo access apparatus 10 (hereinafter also referred to as the “subject apparatus 10,” or more simply “apparatus 10”) for slidable engagement with the floor 106 of a cargo box 104. Apparatus 10 is comprised of at least one lightweight cargo access tray 12 (also referred to herein as “cargo tray 12” or more simply as “tray 12”) which is comprised of a tray floor 14, the floor having a perimeter 16, a top cargo supporting surface 14a, and a bottom bed contacting surface 14b for slidable and frictional engagement with the cargo box floor 106, and a cargo retaining wall 18 attached to or integrally formed with tray floor 14 about its perimeter 16. As best observed upon additional reference to FIG. 8, cargo retaining wall 18 is either normal to tray floor 14 (not shown) or, more preferably, canted outwardly to facilitate stacking of the subject cargo access trays 12 one atop another. Cargo retaining wall 18 may be solid (shown) or hollowed to reduce weight (not shown). The height of retaining wall 18 as measured from the top cargo supporting surface 14a of floor 14 to the top of the retaining wall may range from approximately one inch to approximately 24 inches, and preferably from approximately 1 inch to 5 inches with an ideal height of approximately 3 inches. The height of each at least one tray 12 may range from approximately one and a half inches to approximately 24 inches, and preferably will not exceed four inches to prevent the need to lift cargo higher than that for loading and unloading into the trays. As may be readily appreciated, a wide variety of relatively lightweight cargo 200, such as without limitation, groceries, luggage, boxed items, landscaping materials, outdoor gear/sports equipment, garbage, may be loaded onto the at least one tray 12 which may be pulled rearwardly over the tailgate to facilitate loading and unloading of the cargo thus avoiding the need to climb into the cargo box 104 to retrieve out of reach items.

The at least one cargo tray 12 preferably rectangular or substantially rectangular in shape and preferably but not essentially occupies substantially the entire area of cargo floor 106 between opposing vertical side walls 110 (or between the wheel well defining structures 118 when present), on the one hand, and between front wall 112 and tailgate 114, on the other hand. In preferred embodiments, a pair of trays 12 are deployed within cargo box 104. In preferred embodiments, the pair of trays are equal in size.

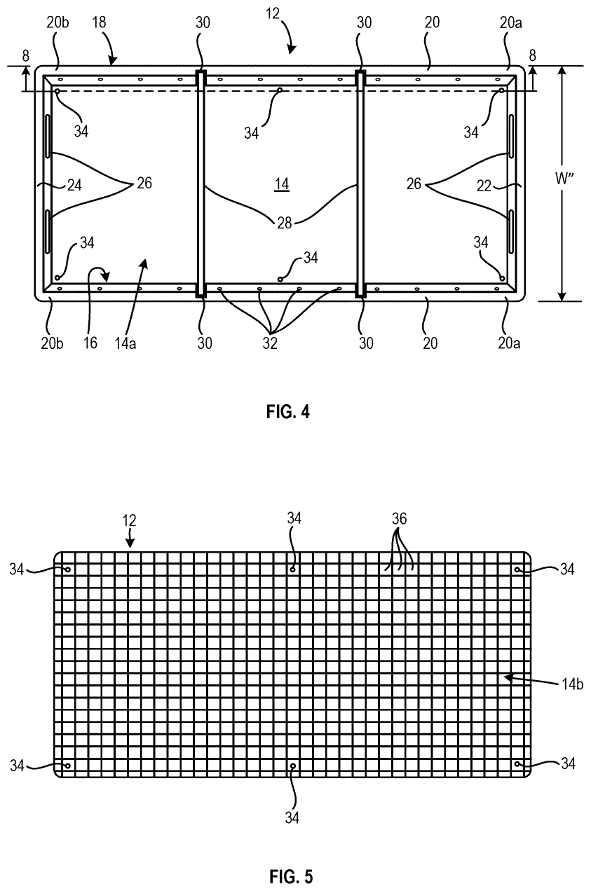

With reference now being made to FIG. 4 in particular, retaining wall 18 of at least one cargo tray 12 is comprised of a pair of opposing side walls 20 each having a first end 20a and a second end 20b, the first end 20a being connected to or integrally formed with a first transverse retaining wall 22 and the second end 20b being connected to or integrally formed with a second transverse retaining wall 24. The length L of each at least one cargo tray is sized such that when fully inserted into cargo box 104, first transverse retaining wall will abut or be in close proximity to front wall 112 of the vehicle and second transverse retaining wall 24 will be in close proximity to tailgate 114 to restrict longitudinal movement of the tray beyond an inch or two in either direction while truck 100 is in operation. When apparatus 10 is comprised of a single tray 12, its width W will be sized such that when inserted into cargo box 104, each side wall 20 will abut or be in close proximity to the truck's vertical side walls 110 (or wheel well defining structures 118 when present) to restrict lateral movement of the tray beyond an inch or two in either direction while truck 100 is in operation. In embodiments where apparatus 10 is comprised of two cargo trays 12, their length L is as described above, and the width W of each such tray 12 is preferably one half of the width W described above. In embodiments of the subject apparatus 10 comprising two or more trays 12, a gap of approximately 1 inch to 2 inches between adjacent trays is desired to permit mounting of cargo retention means as described in greater detail below.

With continued reference to FIGS. 2 through 4, retaining wall 18 of each at least one cargo tray 12 may include at least one hand slot 26 disposed therethrough. Each hand slot 26 is preferably but not essentially oval in shape, and sized to permit receipt of a user's fingers to facilitate grasping of the tray and sliding it into and out of the cargo box 104. In a preferred embodiment, second transverse retaining wall 24 is adapted with a pair of slots 26 to facilitate two-handed manipulation of the tray end. In another preferred embodiment, both first and second transverse retaining walls 22,24 are adapted with a pair of hand slots 26 as shown to facilitate carrying of the tray 12 and any cargo loaded thereon by two people; one at each end of the tray. It should be understood, however, that each tray 12 is constructed to be of relatively light weight such that when empty it can be easily carried by one person, with or without any hand slots 26.

In some embodiments, each at least one tray 12 may further include at least one transverse partition wall 28 between opposing side walls 20 in parallel to first and second transverse retaining walls 22,24 to facilitate segregation and organization of cargo 200. The ends of each partition wall 28 may be removably mounted within a pair of opposing slots 30 or bosses (not shown). Although only two partition walls are shown in FIGS. 2-4 in specific locations, it should be readily appreciated that opposing side walls 20 may be adapted with a plurality of slots 30 or bosses located along the entire length of each side wall between their respective ends 20a,20b to provide a wide variety of partition wall placement options.

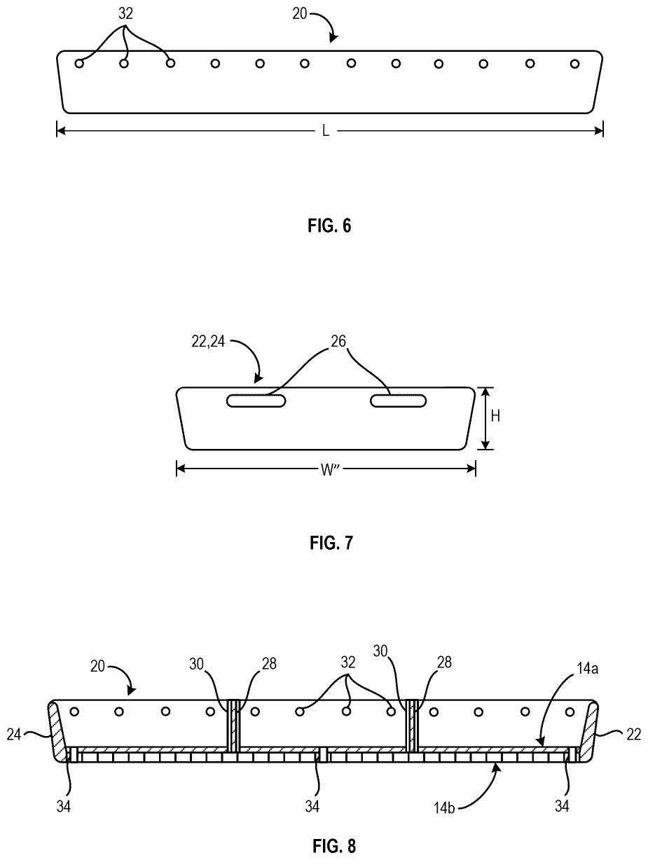

As best observed upon reference to FIG. 6, retaining wall 18 of at least one tray 12 may be adapted with a plurality of apertures 32 disposed therethrough for the removable receipt of hooks and other mounting hardware associated with various cargo retention means such as cargo nets, tie-down straps and the like (not shown). As may be readily appreciated, it is important to leave a space or gap between the cargo retaining wall 18 and any adjacent cargo box side wall 110, front wall 112, tailgate 114 and neighboring tray 12 to permit access to apertures 32 for mounting of cargo retention means.

As best observed upon reference to FIGS. 4 and 5, in certain embodiments, the at least one tray floor 14 may be perforated with one or more drain holes 34 which can be used to permit draining of rainwater or any other liquid from the tray 12 into the truck bed if that feature is desired. At least one drain hole 34 may also, or in the alternative, be disposed through retention wall 18 in close proximity to top cargo supporting surface 14a of floor 14 (not shown). Drain holes 34 may be plugged with rubber or plastic plugs (not shown) to prevent drainage onto the truck bed if desired.

Referring to FIG. 5, in certain embodiments the bottom bed-contacting surface 14b of tray floor 14 may be of a waffle configuration having a plurality of voids 36 as shown to reduce its surface area and thus reduce friction with the cargo box floor 106. Such a configuration also has the advantages of reducing weight, imparting impact resistance, and increasing the strength-to-weight ratio of the at least one tray 12. Other alternative configurations also provide the foregoing characteristics including ribbed and honeycomb configurations for example.

The subject trays 12 may be constructed from a variety of suitable materials selected for certain key properties and characteristics including but not limited to strength, durability, weight, cost, and resistance to heat, UV light, water and chemical erosion. In a preferred embodiment, trays 12 are produced by injection molding using a plastic in the poly family such as polypropylene, polyethylene, polyoxymethylene or even acrylonitrile butadiene styrene, or some other appropriate composition.

Because the surfaces of the subject apparatus 10 may be exposed to rain, splash and spillage of fuel or waste materials, dirt, debris, construction materials and the like, they will require frequent cleaning. Accordingly, in some embodiments, trays 12 may be constructed of a corrosion-resistant, nonabsorbent, and/or smooth material. Such materials should be durable, corrosion-resistant, and nonabsorbent; sufficient in weight and thickness to withstand repeated washing; finished to have a smooth, easily cleanable surface; and resistant to pitting, chipping, crazing, scratching, scoring, distortion, and decomposition. Perimeter wall 18 and cargo supporting surface 14a of floor 14 are preferably constructed to be free of breaks, open seams, cracks, chips, inclusions, pits, and similar imperfections, free of sharp internal angles, corners, and crevices; and finished to have smooth welds and joints (if present).

Embodiments of the subject apparatus 10 may be fabricated from high density polyethylene, a clean, white, high-impact plastic material that is almost unbreakable. As an alternative, the subject apparatus may be fabricated from polypropylene to exhibit very high corrosion-resistance to acidic, alkaline and saline solutions, and can easily withstand temperatures up to 250° F. The polypropylene construction has high tensile strength and tremendous impact strength and very importantly has virtually no water absorption. This material may be used to create a special “skid-proof” textured surface to resist sliding of cargo. Another viable alternative is to fabricate the apparatus from fiberglass which will provide a smooth surface with rounded corners for easy cleaning. Sturdy fiberglass won't dent, chip, bend, peel, crack or warp. Fiberglass is suitable for coloring of apparatus 10, if desired, and is impervious to detergents and resistant to industrial cleaners.

Although the present invention has been described with reference to the particular embodiments herein set forth, it is understood that the present disclosure has been made only by way of example and that numerous changes in details of construction may be resorted to without departing from the spirit and scope of the invention. Thus, the scope of the invention should not be limited by the foregoing specifications, but rather only by the scope of the claims appended hereto.

1. A cargo access apparatus for pickup trucks having a cargo box comprising a floor, a pair of opposing vertical side walls, a transverse front wall and a tailgate opposite the front wall and pivotally mounted to the pair of side walls, the pair of opposing vertical side walls, transverse front wall and tailgate defining an area, the floor, pair of opposing vertical side walls, transverse front wall and tailgate defining a cargo space for receiving cargo, the cargo access apparatus comprising at least one cargo access tray sized to occupy substantially all of the area between the cargo bed side walls, on the one hand, and between the transverse front wall and tailgate of the cargo box, on the other hand, when oriented in side-by-side fashion on the cargo box floor, said at least one cargo access tray comprising:
a. a floor having a perimeter, a top cargo supporting surface, and a bottom bed contacting surface; and
b. a cargo retaining wall attached to or integrally formed with the tray floor about said perimeter;
whereby said bottom bed contacting surface is adapted for slidable and frictional engagement with the cargo box floor; and whereby each of said at least one tray may be independently pulled rearwardly over the tailgate to load or unload cargo onto said cargo supporting surface.

2. The cargo access apparatus of claim 1, wherein said at least one cargo access tray is two trays.

3. The cargo access apparatus of claim 2, wherein said two trays are equal in size.

4. The cargo access apparatus of claim 3, wherein said bottom bed contacting surface of said tray floor has a ribbed, waffle or honeycomb configuration to reduce friction with the cargo box floor.

5. The cargo access apparatus of claim 4, wherein said cargo retaining wall is comprised of a pair of opposing side walls each having a first end and a second end, a first transverse retaining wall, and a second transverse retaining wall, said first end of said pair of opposing side walls being connected to or integrally formed with said first transverse retaining wall and located proximate to said transverse front wall of the cargo bed when deployed within the cargo box, and said second end being connected to or integrally formed with said second transverse retaining wall and located proximate the tailgate when the at least one tray is fully positioned within the cargo box.

6. The cargo access apparatus of claim 5, wherein said cargo retaining wall is either normal to said tray floor or, more preferably, canted outwardly to facilitate stacking of said at least one cargo tray.

7. The cargo access apparatus of claim 6, wherein said cargo retaining wall includes at least one slot disposed therethrough to facilitate grasping of said at least one tray.

8. The cargo access apparatus of claim 7, further including at least one removable transverse partition wall extending between said pair of opposing side walls, intermediate said first and second transverse retaining walls, to facilitate segregation and organization of cargo.

9. The cargo access apparatus of claim 8, further including a plurality of apertures disposed through said cargo retaining wall for removable receipt of cargo retention means such as cargo nets, tie-down straps and the like.

10. The cargo access apparatus of claim 9, further including at least one drain hole disposed through said floor of each said at least one tray.

11. A cargo access apparatus for pickup trucks having a cargo box comprising a floor, a pair of opposing vertical side walls each having a wheel well defining structure extending therefrom, a transverse front wall and a tailgate opposite the front wall and pivotally mounted to the pair of side walls, the pair of opposing vertical side walls, wheel well defining structures, transverse front wall and tailgate defining an area, the floor, pair of opposing vertical side walls, wheel well defining structures, transverse front wall and tailgate defining a cargo space for receiving cargo, the cargo access apparatus comprising at least one cargo access tray sized to occupy substantially all of the area between the wheel well defining structures, on the one hand, and between the transverse front wall and tailgate of the cargo box, on the other hand, when oriented in side-by-side fashion on the cargo box floor, said at least one cargo access tray comprising:
a. a floor having a perimeter, a top cargo supporting surface, and a bottom bed contacting surface; and
b. a cargo retaining wall attached to or integrally formed with the tray floor about said perimeter;
whereby said bottom bed contacting surface is adapted for slidable and frictional engagement with the cargo box floor; and whereby each of said at least one tray may be independently pulled rearwardly over the tailgate to load or unload cargo onto said cargo supporting surface.

12. The cargo access apparatus of claim 11, wherein said at least one cargo access tray is two trays.

13. The cargo access apparatus of claim 12, wherein said two trays are equal in size.

14. The cargo access apparatus of claim 13, wherein said bottom bed contacting surface of said tray floor has a ribbed, waffle or honeycomb configuration to reduce friction with the cargo box floor.

15. The cargo access apparatus of claim 14, wherein said cargo retaining wall is comprised of a pair of opposing side walls each having a first end and a second end, a first transverse retaining wall, and a second transverse retaining wall, said first end of said pair of opposing side walls being connected to or integrally formed with said first transverse retaining wall and located proximate to said transverse front wall of the cargo bed when deployed within the cargo box, and said second end being connected to or integrally formed with said second transverse retaining wall and located proximate the tailgate when the at least one tray is fully positioned within the cargo box.

16. The cargo access apparatus of claim 15, wherein said cargo retaining wall is either normal to said tray floor or, more preferably, canted outwardly to facilitate stacking of said at least one cargo tray.

17. The cargo access apparatus of claim 16, wherein said cargo retaining wall includes at least one slot disposed therethrough to facilitate grasping of said at least one tray.

18. The cargo access apparatus of claim 17, further including at least one removable transverse partition wall extending between said pair of opposing side walls, intermediate said first and second transverse retaining walls, to facilitate segregation and organization of cargo.

19. The cargo access apparatus of claim 18, further including a plurality of apertures disposed through said cargo retaining wall for removable receipt of cargo retention means such as cargo nets, tie-down straps and the like.

20. The cargo access apparatus of claim 19, further including at least one drain hole disposed through said floor of each said at least one tray.
